(19) United States
(12) Patent Application Publication
(10) Pub. No.: US 2020/0242507 A1
(43) Pub. Date: Jul. 30, 2020

(54) LEARNING DATA-AUGMENTATION FROM UNLABELED MEDIA

(71) Applicant: International Business Machines Corporation, Armonk, NY (US)

(72) Inventors: Chuang Gan, Cambridge, MA (US); Quanfu Fan, Lexington, MA (US); Sijia Liu, Somerville, MA (US); Rogerio Schmidt Feris, Hartford, CT (US)

(21) Appl. No.: 16/257,965

(22) Filed: Jan. 25, 2019

(51) Int. Cl. G06N 20/00; H04N 21/4402; H04N 21/439; G06N 3/08

(52) U.S. Cl. CPC G06N 20/00; G06N 3/08; H04N 21/4398; H04N 21/4402

(57) ABSTRACT

A computing system is configured to learn data-augmentations from unlabeled media. The system includes an extracting unit and an embedding unit. The extracting unit is configured to receive media data that includes moving images of an object and audio generated by the object. The extracting unit extracts an image frame of the object among the moving images and extracts an audio segment from the audio. The embedding unit is configured to generate first embeddings of the image frame and second embeddings of the audio segment, and to concatenate the first and second embeddings together to generate concatenated embeddings. The computing system labels the media data based at least in part on the concatenated embeddings.

### BACKGROUND

The present invention generally relates to data processing systems, and more specifically, to machine-learning computing systems.

Machine-learning techniques have significantly advanced to the point where character recognition and image recognition can be achieved using machine-learning computing systems. The term “machine learning” typically describes a primary function of electronic systems that learn from data. In machine learning and cognitive science, neural networks are a family of statistical learning models inspired by the biological neural networks of animals, and in particular the brain.

Neural networks can be used to estimate or approximate systems and functions that depend on a large number of inputs and are generally unknown. Neural networks use a class of algorithms based on a concept of inter-connected “neurons.” In a typical neural network, neurons have a given activation function that operates on the inputs. By determining proper connection weights (a process also referred to as “training”), a neural network achieves efficient recognition of the desired patterns, such as images and characters. Oftentimes, these neurons are grouped into “layers” in order to make connections between groups more obvious and to each computation of values. Training the neural network is a computationally intense process.

### SUMMARY

Embodiments of the present invention provide a computer-implemented method is provided to learn data-augmentations from unlabeled media. The method comprises receiving media data including moving images of an object and audio generated by the object. The method further includes extracting an image frame of the object among the moving images and extracting an audio segment from the audio, and generating first embeddings of the image frame and second embeddings of the audio segment. The method further comprises concatenating the first and second embeddings together to generate concatenated embeddings, and labeling the media data based at least in part on the concatenated embeddings.

Embodiments of the invention provide a computer program product for learning data-augmentations from unlabeled media. The computer program product comprises a computer readable storage medium having program instructions embodied therewith. The program instructions are executable by a system comprising one or more processors to cause the system to perform a method. A non-limiting example of the method comprises receiving media data including moving images of an object and audio generated by the object. The method further includes extracting an image frame of the object among the moving images and extracting an audio segment from the audio, and generating first embeddings of the image frame and second embeddings of the audio segment. The method further comprises concatenating the first and second embeddings together to generate concatenated embeddings, and labeling the media data based at least in part on the concatenated embeddings.

According to another non-limiting embodiment, a computing system is configured to learn data-augmentations from unlabeled media. The system includes an extracting unit and an embedding unit. The extracting unit is configured to receive media data that includes moving images of an object and audio generated by the object. The extracting unit extracts an image frame of the object among the moving images and extracts an audio segment from the audio. The embedding unit is configured to generate first embeddings of the image frame and second embeddings of the audio segment, and to concatenate the first and second embeddings together to generate concatenated embeddings. The computing system labels the media data based at least in part on the concatenated embeddings

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 depicts an exemplary computer system capable of implementing one or more embodiments of the present invention;

FIG. 4 is a block diagram of a conditional variational autoencoder (VAE) in accordance with one or more embodiments of the present invention;

FIG. 5 depicts a learning data augmentation system according to a non-liming embodiment of the present invention; and

FIG. 6 depicts a learning data augmentation system according to a non-liming embodiment of the present invention;

FIG. 7 depicts a learning data augmentation system according to a non-liming embodiment of the present invention; and

FIG. 8 is a flow diagram illustrating a method of learning data-augmentations from unlabeled media according to a non-limiting embodiment of the invention.

The diagrams depicted herein are illustrative. There can be many variations to the diagram or the operations described therein without departing from the spirit of the invention. For instance, the actions can be performed in a differing order or actions can be added, deleted, or modified. Also, the term “coupled” and variations thereof describes having a communications path between two elements and does not imply a direct connection between the elements with no intervening elements/connections between them. All of these variations are considered a part of the specification.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems; storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Turning now to an overview of technologies that are more specifically relevant to aspects of the present invention, deep neural networks (DNNs), and convolutional neural networks (CNNs) in particular, are successful in analyzing visual imagery. Effectively training DNNs, however, requires a large volume of data, and conventional DNNs generally perform poorly on few-shot learning tasks. Data augmentation is critical to avoid overfitting when training DNNs especially when only a small amount labeled training examples are available. Further, traditional data augmentation intuitively involves a limited set of known invariances such as cropping, scaling and occluding.

Various non-limiting embodiments described herein aim to solve the problems of the conventional art by providing a computing system that implements a CCN configured to perform a data augmentation process that can use few-shot learning tasks to effectively train the CCN. In one or more non-limiting embodiments of the invention, the CCN learns data augmentation from an unlabeled video by performing facial recognition techniques to obtain the few shot face recognition tasks.

In one or more embodiments, a conditional variational autoencoder (VAE) is implemented to generate human faces with complex transformations, along with one or more audio features of the person associated with the face. Compared with conventional data augmentation techniques, the teachings of the present invention can obtain complex transformations from original training examples to gain a sufficient amount of data for facilitating few-shot learning. In addition, the CCN described herein can learn a generative model from the unlabeled media data (e.g., an unlabeled video), thereby avoiding the need to gather and store a large volume of labeled data.

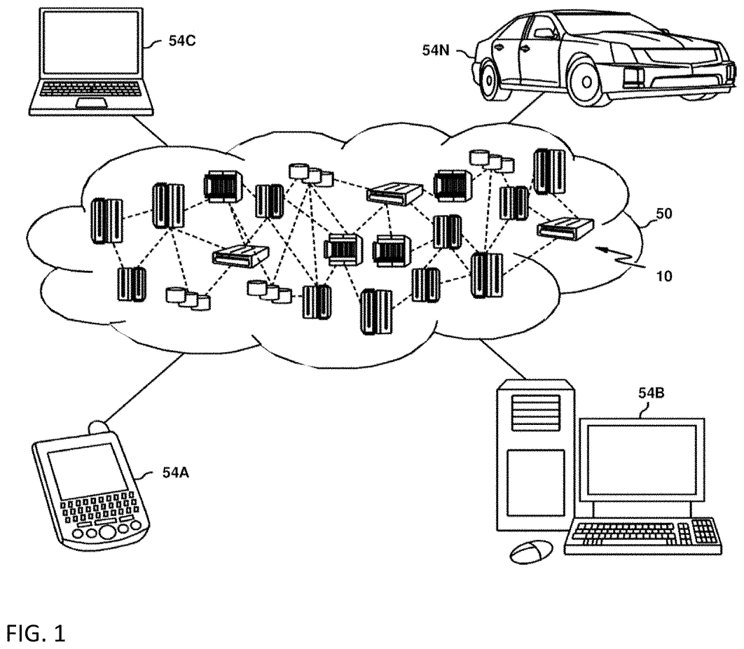

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms, and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

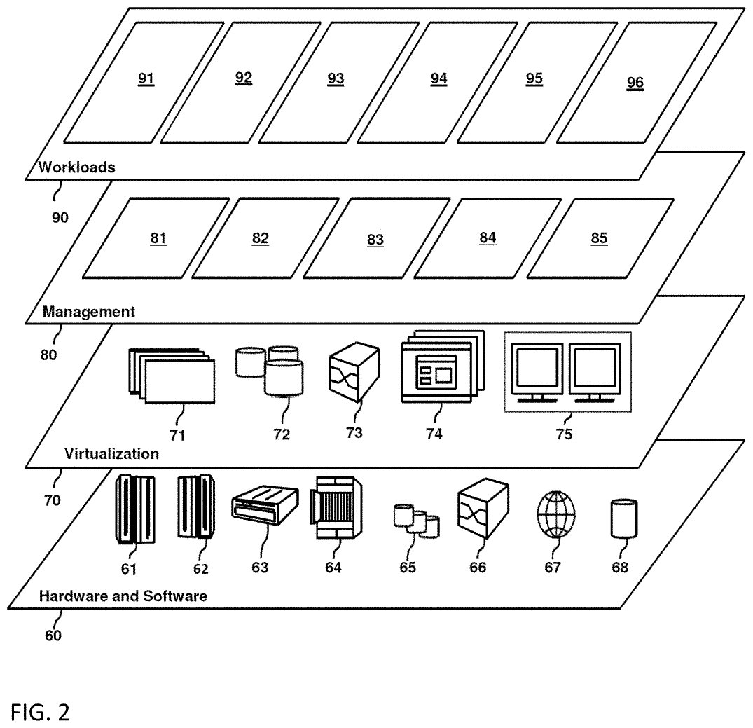

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and video alteration processing 96.

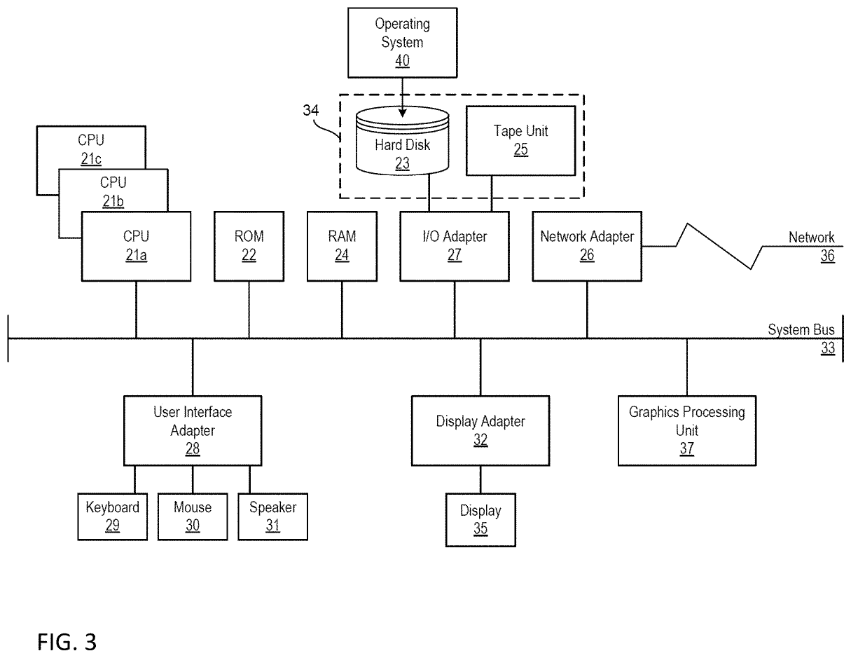

With reference to FIG. 3, a high-level block diagram is illustrated showing an example of a computer-based system 300 that is useful for implementing one or more embodiments of the invention. Although one exemplary computer system 300 is shown, computer system 300 includes a communication path 326, which connects computer system 300 to additional systems and may include one or more wide area networks (WANs) and/or local area networks (LANs) such as the internet, intranet(s), and/or wireless communication network(s). Computer system 300 and additional systems are in communication via communication path 326, (e.g., to communicate data between them).

Computer system 300 includes one or more processors, such as processor 302. Processor 302 is connected to a communication infrastructure 304 (e.g., a communications bus, cross-over bar, or network). Computer system 300 can include a display interface 306 that forwards graphics, text, and other data from communication infrastructure 304 (or from a frame buffer not shown) for display on a display unit 308. Computer system 300 also includes a main memory 310, preferably random access memory (RAM), and may also include a secondary memory 312. Secondary memory 312 may include, for example, a hard disk drive 314 and/or a removable storage drive 316, representing, for example, a floppy disk drive, a magnetic tape drive, or an optical disk drive. Removable storage drive 316 reads from and/or writes to a removable storage unit 318 in a manner well known to those having ordinary skill in the art. Removable storage unit 318 represents, for example, a floppy disk, a compact disc, a magnetic tape, or an optical disk, etc., which is read by and written to by a removable storage drive 316. As will be appreciated, removable storage unit 318 includes a computer readable medium having stored therein computer software and/or data.

In some alternative embodiments of the invention, secondary memory 312 may include other similar means for allowing computer programs or other instructions to be loaded into the computer system. Such means may include, for example, a removable storage unit 320 and an interface 322. Examples of such means may include a program package and package interface (such as that found in video game devices), a removable memory chip (such as an EPROM or PROM) and associated socket, and other removable storage units 320 and interfaces 322 which allow software and data to be transferred from the removable storage unit 320 to computer system 300.

Computer system 300 may also include a communications interface 324. Communications interface 324 allows software and data to be transferred between the computer system and external devices. Examples of communications interface 324 may include a modem, a network interface (such as an Ethernet card), a communications port, or a PCM-CIA slot and card, etc. Software and data transferred via communications interface 324 are in the form of signals which may be, for example, electronic, electromagnetic, optical, or other signals capable of being received by communications interface 324. These signals are provided to communications interface 324 via communication path (i.e., channel) 326. Communication path 326 carries signals and may be implemented using a wire or cable, fiber optics, a phone line, a cellular phone link, an RF link, and/or other communications channels.

In the present disclosure, the terms “computer program medium,” “computer usable medium,” and “computer readable medium” are used to generally refer to media such as main memory 310 and secondary memory 312, removable storage drive 316, and a hard disk installed in hard disk drive 314. Computer programs (also called computer control logic) are stored in main memory 310, and/or secondary memory 312. Computer programs may also be received via communications interface 324. Such computer programs, when run, enable the computer system to perform the features of the present disclosure as discussed herein. In particular, the computer programs, when run, enable processor 302 to perform the features of the computer system. Accordingly, such computer programs represent controllers of the computer system.

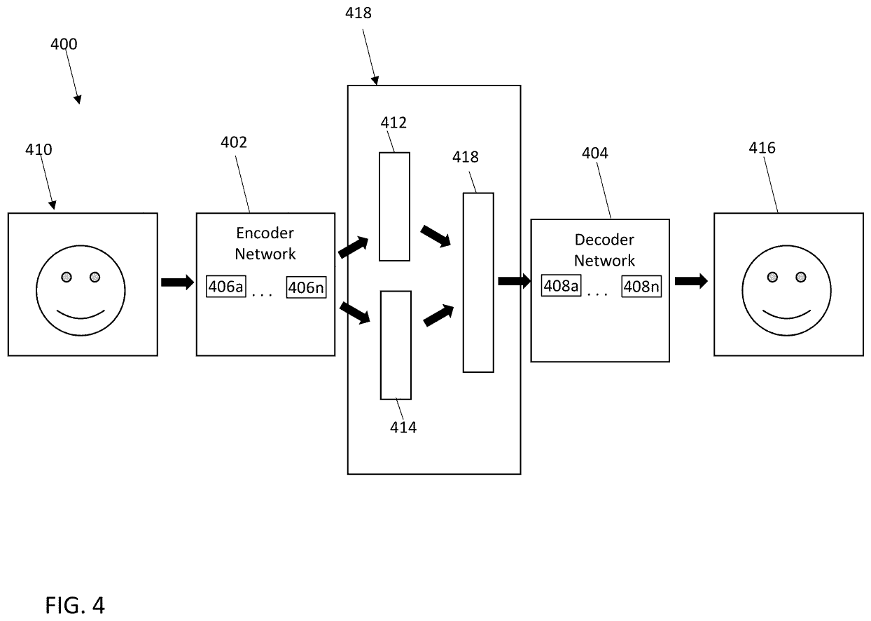

Referring now to FIG. 4, a conditional variational autoencoder (VAE) 400 is illustrated in accordance with one or more embodiments of the present invention. The conditional VAE 400 includes an encoder network 402 and a decoder network 404. The encoder network 402 includes one or more convolution layers 406a-406n, while the decoder network 404 includes one or more deconvolution layers 408a-408n. The encoder network 402 receives an original image 410, and uses the convolution layers 406a-406n to encode the original image 410 into a representative encoded vector. The coded vector can be represented as a vector of means 412 and a vector of standard deviations 414, which can be utilized to represent a distinct original image 410.

The deconvolution layers 408a-408n serve as a generative network that uses transpose convolutions to receive the encoded vector from the encoder network 402. The encoded vectors are then decoded to obtain the code representing the original image 410, which is then generated as the output image 416 accordingly.

The conditional VAE 400 further includes constraints which force the encoder 402 to generate latent vectors 418 that roughly follow a unit gaussian distribution. Accordingly, the conditional VAE 400 can generate new images 416 by sampling a latent vector 418 from the unit gaussian and passing it into the decoder 404.

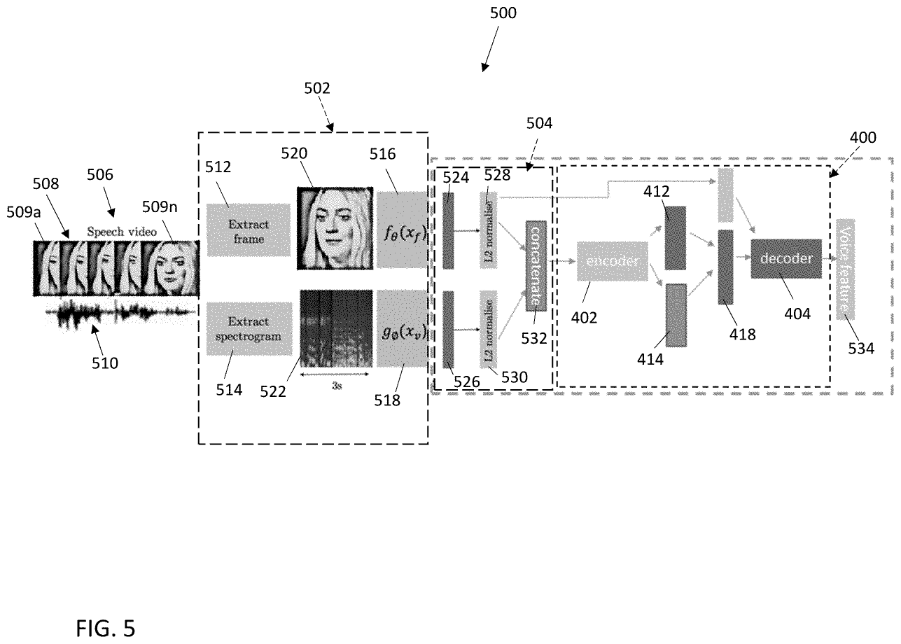

Turning to FIG. 5, a learning data augmentation system 500 is illustrated according to a non-liming embodiment of the present invention. The learning data augmentation system 500 includes an extracting unit 502, an embedding unit 504, and a conditional VAE 400. Any one of the extracting unit 502, embedding unit 504 and conditional VAE 400 can be constructed as an electronic hardware controller that includes memory and a processor configured to execute algorithms and computer-readable program instructions stored in the memory.

The extracting unit 502 receives media data 506. The media data includes, for example, a moving visual media 506 such as, for example, a video 506 that is embedded with moving image data 508 an audio data 510. The moving image data 508 includes a plurality of sequentially captured still image frames 509a-509n of an object such as a person, animal, etc., and the audio data 510 is audio corresponding to the object. In the case where the moving image data 508 is a person, the audio data 510 is the person's voice or speech. In the case the moving image data 508 is a bird, for example, the audio data 510 is the bird's song, call, or chirp.

The extracting unit 502 includes a frame extracting unit 512, a spectrograph unit 514, a face subnetwork 516, and a voice subnetwork 518. Any one of the frame extracting unit 512, spectrograph unit 514, face subnetwork 516, and voice subnetwork 518 can be constructed as an electronic hardware controller that includes memory and a processor configured to execute algorithms and computer-readable program instructions stored in the memory.

The frame extracting unit 502 extracts a positive image frame 520, while the spectrograph unit 514 extracts a positive audio segment 522. In one or more embodiments, the extracted image frame 520 corresponds to point of time within the moving image data 508. The extracted image frame 520 and audio segment 522 are then fed into a two-stream architecture including the face subnetwork 516 and the voice subnetwork 518, each producing embeddings (e.g., 256×1) 524 and 526, respectively. The embedding can be referred to as a process of embedding an image into a d-dimensional Euclidean space. A curriculum-based mining schedule can be used to select appropriate negative pairs which are then trained using a contrastive loss.

The embedding unit 504 includes first and second normalizing units 528, 530, and a concatenate unit 532. Any one of the first normalizing unit 528, the second normalizing unit 530, and the concatenate unit 532 can be constructed as an electronic hardware controller that includes memory and a processor configured to execute algorithms and computer-readable program instructions stored in the memory.

The first normalizing unit 528 receives the embedding 524 corresponding to the extracted image frame 520, while the second normalizing unit 530 receives the embedding 526 corresponding to the extracting audio segment 522. The first and second normalizing units 528 and 530 can apply a vector L2 norm algorithm, for example, to normalize the embeddings 524 and 526. The normalized embeddings are then output to the concatenate unit 532, where they are concatenated, i.e., merged together. The concatenated embeddings are delivered to the conditional VAE 400, where they are used as an input to the encoder 402.

The decoder 404 operates in a similar way to the encoder 402. For example, the decoder 404 is configured to generate a mapping from the latent variables to a new set of parameters defining a new set of associated probability distributions. Samples are then taken, and the final samples are viewed as the output of CNN. The system 500 aims to approximate the output object or feature 534 as much as possible to the input, e.g., the extracted image frame 520: Accordingly, the system 500 can add a label to the decoded data. The label can include an identity of the object in connection with the voice (or vice versa), an identify of the hallucination applied to the object, etc.

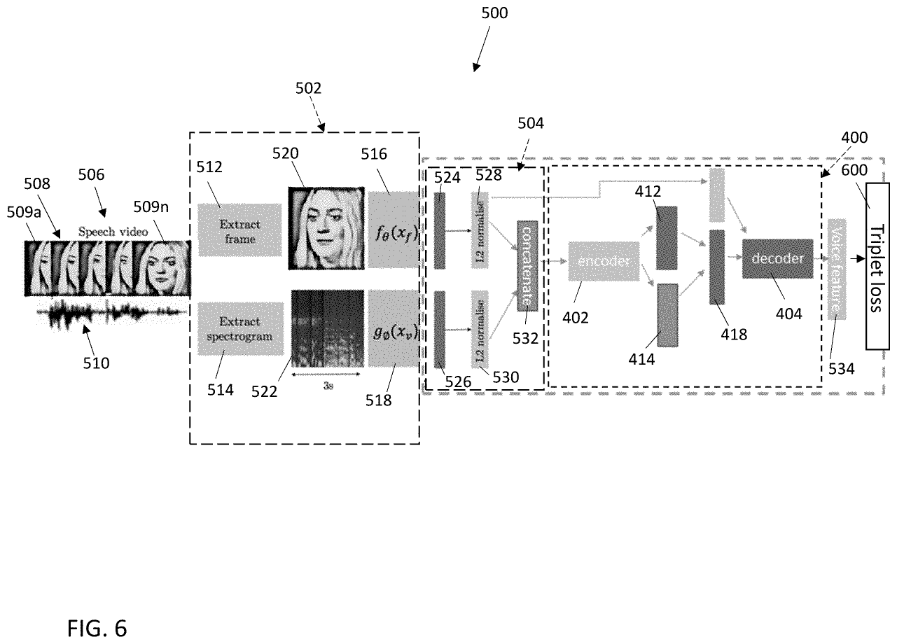

In one or more embodiments of the present invention, the learning data augmentation system 500 can include a triplet loss unit 600 (see FIG. 6). The triplet loss unit 600 can be constructed as a controller, which takes in the decoded audio feature 534, which serves as an “anchor” or reference. The triplet loss unit 600 also receives a positive example (e.g., another audio feature corresponding to the extracted image frame 520), and a negative example (an audio feature from another object different from the object of the extracted image frame 520). The triplet loss unit 600 operates such that the cosine similarity between the anchor and the positive example is larger than the cosine similarity between the anchor and the negative example. In other words, the triplet loss unit 600 aims to bring close the anchor (i.e., extracted image frame) with the positive example, (i.e., the record that is in theory similar with the anchor) as far as possible from the negative example (i.e., the record that is different from the anchor). The triplet loss that is being minimized by the triplet loss unit 600 can be described as follows:

$${\sum }_{i}^{N} {[ {‖ f ( {x}_{i}^{a} ) - f ( {x}_{i}^{p} ) ‖}_{2}^{2} - {‖ f ( {x}_{i}^{a} ) - f ( {x}_{i}^{n} ) ‖}_{2}^{2} + α ]}_{+} .$$

In the expression above, x^{a} is the anchor image, x^{p} is the positive example, xⁿ is the negative example, and α is a margin that is enforced between positive and negative pairs. By minimizing the loss, the accuracy of the decoded audio feature 534 is improved.

In one or more embodiments of the present invention, the learning data augmentation system 500 can introduce a larger invariance space, which allows for hallucinating the extracted image frame 520 to generate a hallucinated feature 701 of the object included in the media data 506. A hallucination includes, for example, generating objects (e.g., faces) in different lighting conditions, hallucinating a pose of the object, e.g., hallucinating a facial expression of the extracted face, and hallucinating the voice corresponding to the extracted face with gender characteristics, nationality characteristics, and age characteristics. Accordingly, additional training examples can be generated using few-shot learning tasks.

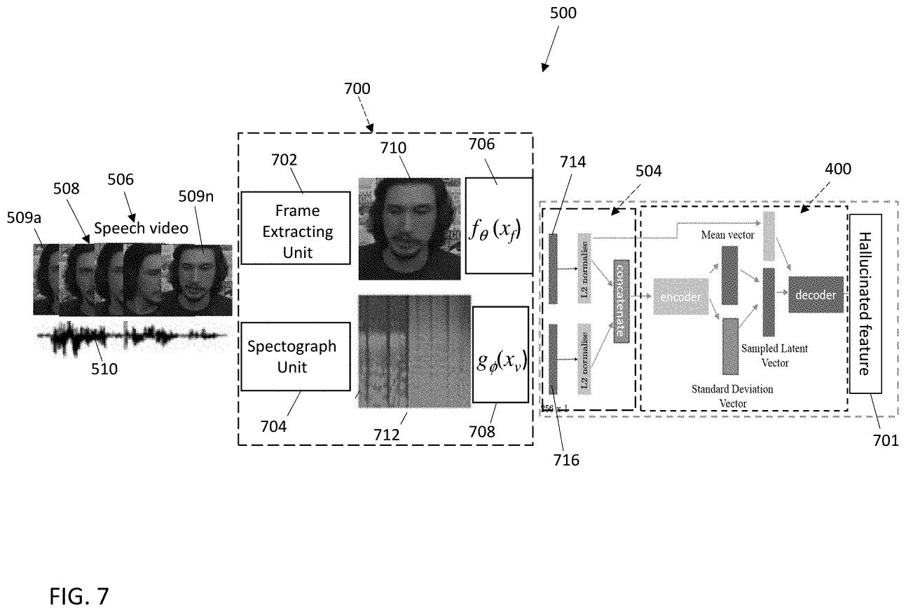

Turning to FIG. 7, for example, the learning data augmentation system 500 can implement a hallucination unit 700, an embedding unit 504, and a conditional VAE 400. Any one of the hallucination unit 700, the embedding unit 504, and the conditional VAE 400 can be constructed as an electronic hardware controller that includes memory and a processor configured to execute algorithms and computer-readable program instructions stored in the memory. The embedding unit 504 and conditional VAE 400 operate as described above, and their descriptions will not be repeated for the sake of brevity.

The hallucination unit 700 includes a frame extraction unit 702, a spectrograph unit 704, a face subnetwork 706, and a voice subnetwork 708. The frame extraction unit 702 extracts a positive image frame 710, while the spectrograph unit 704 extracts an audio segment 712. In this case, the audio segment 712 includes can include, for example, an utterance, speech, voice, etc., different from an original audio segment associated with the image frame 710. The extracted image frame 710 and audio segment 712 are fed to the face subnetwork 706 and the voice subnetwork 708, respective, where each produces embeddings (e.g., 256×1) 714 and 716, respectively. Accordingly, the embedding unit 504 and conditional VAE 400 operate to generate the hallucinated object feature 701.

Although not illustrated, the hallucination unit 700 can include a second frame extraction unit that extracts a second positive image frame different from image frame 710. The second image frame can be used extract a different facial expression or pose compared to the facial expression or pose of the first extracted image 710. The different facial expression or pose can then be used to hallucinate a physical feature (e.g., facial expression, pose, etc.), which is applied to the first positive image frame 710.

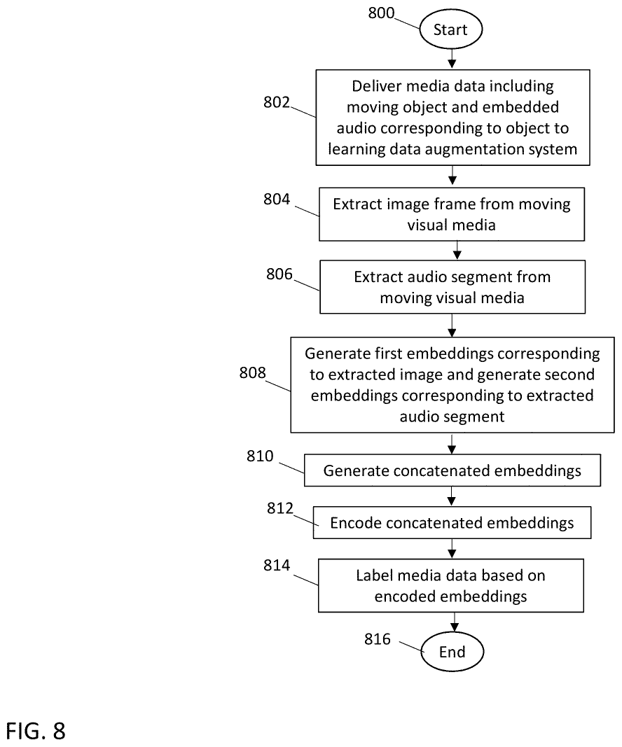

Referring now to FIG. 8, a flow diagram illustrates a method of learning data-augmentations from unlabeled media according to a non-limiting embodiment of the invention. The method begins at operation 800, and at operation 802 media data (e.g., a video) including a moving object (a moving person) and embedded audio (e.g., the person's voice or speech) corresponding to object is delivered to the learning data augmentation system described herein. At operation 804, an image frame is extracted from the media data. In one or more embodiments of the invention, the image frame is extracted at a time point from within a video. At operation 806, an audio segment is extracted from the media data. In one or more embodiments, the audio segment is extracted by generating a spectrogram of the embedded audio at the time point at which the image frame is extracted. At operation 808, first embedding are generated corresponding to the extracted image frame, and second embedding are generated corresponding to the extracted audio segment. At operation 810, the first and second embeddings are concatenated, and the concatenated embeddings are encoded at operation 812. At operation 814, the media data is labeled based at least in part on the encoded concatenated embedding, and the operation ends at operation 816. The label can include an identity of the object in connection with the voice (or vice versa), an identify of the hallucination applied to the object, etc.

As described herein, a CCN is provided that implements a learning data augmentation system configured to perform a data augmentation process that can use few-shot learning tasks to effectively train the CCN. In one or more embodiments, a conditional variational autoencoder (VAE) is implemented to generate human faces with complex transformations, along with one or more audio features of the person associated with the face. Compared with conventional data augmentation techniques, the teachings of the present invention can obtain complex transformations from original training examples to gain a sufficient amount of data for facilitating few-shot learning. In addition, the CCN described herein can learn a generative model from the unlabeled media data (e.g., an unlabeled video), thereby avoiding the need to gather and store a large volume of labeled data

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method of learning data-augmentations from unlabeled media, the method comprising:
receiving media data including moving images of an object and audio generated by the object;
extracting an image frame of the object among the moving images and extracting an audio segment from the audio;
generating first embeddings of the image frame and second embeddings of the audio segment;
concatenating the first and second embeddings together to generate concatenated embeddings; and
labeling the media data based at least in part on the concatenated embeddings.

2. The computer-implemented method of claim 1, wherein the image frame is extracted at a point of time in the media data.

3. The computer-implemented method of claim 2, wherein the audio segment is extracted at the point of time corresponding to the extracted image frame.

4. The computer-implemented method of claim 3, wherein the audio segment is extracted in response to generating a spectrogram of the audio at the point of time corresponding to the extracted image frame.

5. The computer-implemented method of claim 4, further comprising encoding the concatenated embeddings, and labeling the media data based at least in part on the encoded concatenated embeddings.

6. The computer-implemented method of claim 5, further comprising:
decoding the encoded concatenated embeddings based at least in part on the first embeddings of the image frame and latent vectors of the encoded concatenated embeddings; and
generating a voice feature of the object in response to decoding the encoded concatenated embeddings.

7. The computer-implemented method of claim 5, further comprising:
decoding the encoded concatenated embeddings based at least in part on the first embeddings of the image frame and latent vectors of the encoded concatenated embeddings; and
generating a hallucinated feature of the object in response to decoding the encoded concatenated embeddings.

8. A computer program product to learn data-augmentations from unlabeled media, the computer program product comprising a computer readable storage medium having program instructions embodied therewith, the program instructions executable by a system comprising one or more processors to cause the system to perform a method, the method comprising:
receiving media data including moving images of an object and audio generated by the object;
extracting an image frame of the object among the moving images and extracting an audio segment from the audio;
generating first embeddings of the image frame and second embeddings of the audio segment;
concatenating the first and second embeddings together to generate concatenated embeddings; and
labeling the media data based at least in part on the concatenated embeddings.

9. The computer program product of claim 8, wherein the image frame is extracted at a point of time in the media data.

10. The computer program product of claim 9, wherein the audio segment is extracted at the point of time corresponding to the extracted image frame.

11. The computer program product of claim 10, wherein the audio segment is extracted in response to generating a spectrogram of the audio at the point of time corresponding to the extracted image frame.

12. The computer program product of claim 11, further comprising encoding the concatenated embeddings, and labeling the media data based at least in part on the encoded concatenated embeddings.

13. The computer program product of claim 12, further comprising:
decoding the encoded concatenated embeddings based at least in part on the first embeddings of the image frame and latent vectors of the encoded concatenated embeddings; and
in response to decoding the encoded concatenated embeddings, generating one or both of a voice feature of the object and a hallucinated feature of the object.

14. A computing system configured to learn data-augmentations from unlabeled media, the system comprising:
an extracting unit configured to receive media data that includes moving images of an object and audio generated by the object, to extract an image frame of the object among the moving images and to extract an audio segment from the audio; and
an embedding unit configured to generate first embeddings of the image frame and second embeddings of the audio segment, and to concatenate the first and second embeddings together to generate concatenated embeddings,
wherein the computing system labels the media data based at least in part on the concatenated embeddings.

15. The computing system of claim 14, wherein the extracting unit extracts the image frame at point of time in the media data.

16. The computing system of claim 15, wherein the extracting unit extracts the audio segment at the point of time corresponding to the extracted image frame.

17. The computing system of claim 16, wherein the extraction unit extracts the audio segment in response to generating a spectrogram of the audio at the point of time corresponding to the extracted image frame.

18. The computing system of claim 17, further comprising a conditional variational autoencoder (VAE) configured to encode the concatenated embeddings, wherein the media data is labeled based at least in part on the encoded concatenated embeddings.

19. The computing system of claim 18, wherein the conditional VAE decodes the encoded concatenated embeddings based at least in part on the first embeddings of the image frame and latent vectors of the encoded concatenated embeddings; wherein the conditional VAE generates a voice feature of the object in response to decoding the encoded concatenated embeddings.

20. The computing system of claim 18, further comprising:
wherein the conditional VAE decodes the encoded concatenated embeddings based at least in part on the first embeddings of the image frame and latent vectors of the encoded concatenated embeddings; and wherein the conditional VAE generates a hallucinated feature of the object in response to decoding the encoded concatenated embeddings.
